(19) United States
(12) Patent Application Publication
(10) Pub. No.: US 2015/0125833 A1
(43) Pub. Date: May 7, 2015

(54) METHOD AND SYSTEM FOR TRACKING USER ACTIVITIES RESPECTIVE OF A RECIPE AND MULTIMEDIA SEGMENTS CAPTURED BY A USER DEVICE

(71) Applicant: Cortica, Ltd., RAMAT GAN (IL)

(72) Inventors: Igal Raichelgauz, New York, NY (US); Karina Odinaev, New York, NY (US); Yehoshua Y. Zeevi, Haifa (IL)

(73) Assignee: Cortica, Ltd., RAMAT GAN (IL)

(21) Appl. No.: 14/596,553

(22) Filed: Jan. 14, 2015

Related U.S. Application Data
(63) Continuation-in-part of application No. 13/770,603, filed on Feb. 19, 2013.
Application No. 13/770,603 is a continuation-in-part of application No. 13/624,397, filed on Sep. 21, 2012.
Application No. 13/624,397 is a continuation-in-part of application No. 13/344,400, filed on Jan. 5, 2012, now Pat. No. 8,959,037.
Application No. 13/344,400 is a continuation-in-part of application No. 12/434,221, filed on May 1, 2009, now Pat. No. 8,112,376.
Application No. 13/624,397 is a continuation-in-part of application No. 12/195,863, filed on Aug. 21, 2008, now Pat. No. 8,326,775.
Application No. 12/195,863 is a continuation-in-part of application No. 12/084,150, filed on Apr. 7, 2009, now Pat. No. 8,655,801.
Application No. 13/624,397 is a continuation-in-part of application No. 12/084,150, filed on Apr. 7, 2009, now Pat. No. 8,655,801.
Application No. 13/344,400 is a continuation-in-part of application No. 12/195,863, filed on Aug. 21, 2008, now Pat. No. 8,326,775.
Application No. 12/195,863 is a continuation-in-part of application No. 12/084,150, filed on Apr. 7, 2009, now Pat. No. 8,655,801.
(60) Provisional application No. 61/928,467, filed on Jan. 17, 2014.

(30) Foreign Application Priority Data
Oct. 26, 2005 (IL) 171577
Jan. 29, 2006 (IL) 173409
Aug. 21, 2007 (IL) 185414

(51) Int. Cl. G09B 19/00; G09B 5/00

(52) U.S. Cl. CPC G09B 19/0092; G09B 5/00
USPC 434/127

(57) ABSTRACT

A system and method for identification of a deviation from an expected activities sequence are provided. The method includes receiving at least one recipe as an input from a user device; generating, by a signature generator system, a sequence of expected signatures respective of the at least one recipe; receiving a sequence of multimedia segments from the user device; generating, by a signature generator system, at least one signature for each multimedia segment of the sequence of multimedia segments; matching each of the at least one signature to at least a portion of the expected sequence of signatures; and providing a notification to the user device upon identification of a deviation from an expected match.

### CROSS-REFERENCE TO RELATED APPLICATIONS

This application claims the benefit of U.S. Provisional Application No. 61/928,467, filed on Jan. 17, 2014. This application is also a CIP of U.S. patent application Ser. No. 13/770,603 filed on Feb. 19, 2013, now pending, which is a CIP of U.S. patent application Ser. No. 13/624,397 filed on Sep. 21, 2012, now pending. The Ser. No. 13/624,397 application is a CIP of:

(a) U.S. patent application Ser. No. 13/344,400 filed on Jan. 5, 2012, now allowed, which is a continuation of U.S. patent application Ser. No. 12/434,221 filed on May 1, 2009, now U.S. Pat. No. 8,112,376. The Ser. No. 13/344,400 application is also a continuation-in-part of the below-referenced U.S. patent application Ser. No. 12/195,863 and the below-referenced U.S. patent application Ser. No. 12/084,150;

(b) U.S. patent application Ser. No. 12/195,863, filed on Aug. 21, 2008, now U.S. Pat. No. 8,326,775, which claims priority under 35 USC 119 from Israeli Application No. 185414 filed on Aug. 21, 2007, and which is also a continuation-in-part of the below-referenced U.S. patent application Ser. No. 12/084,150; and

(c) U.S. patent application Ser. No. 12/084,150 having a filing date of Apr. 7, 2009, now U.S. Pat. No. 8,655,801, which is the National Stage of International Application No. PCT/IL2006/001235 filed on Oct. 26, 2006, which claims foreign priority from Israeli Application No. 171577 filed on Oct. 26, 2005 and Israeli Application No. 173409 filed on Jan. 29, 2006.

All of the applications referenced above are herein incorporated by reference for all that they contain.

### TECHNICAL FIELD

The present disclosure relates generally to tracking activities of a user respective of a prescribed action list, and more specifically to a system and method for receiving a recipe as an input and tracking a user's activities respective thereof.

### BACKGROUND

Wearable computer devices (WCDs) are becoming a more practical solution for machine-person interaction. A WCD may be, for example, a bracelet, glasses, a pendant, headgear, and the like that is capable of collecting signals related to the user's activity and is worn by the user in order to ease or supplement daily life.

The collection of signals, which may include multimedia segments, is conducted by one or more sensors integrated in the WCD. A WCD may further comprise a network interface, a processing unit, and display technology to allow it to provide content, online or otherwise, respective of the user activity, to the user through the WCD. The problem with such WCDs is that the task of identifying the exact content which the user is interested in among the collected signals is quite complex. In WCDs, such as, for example, optical head-mounted display (OHMD), e.g., Google Glass®, many signals are constantly collected as they are positioned over a users eyes, thereby collecting all elements located in the users view point. The determination which of such collected signals is a targeted signal requires constant analysis of the collected elements and identifying the target signal(s) respective thereof.

It would therefore be advantageous to provide a solution that would enable a user the user to send instructions and track the completion of such instructions by analyzing signals collected by, for example, a WCD.

### SUMMARY

A summary of several example aspects of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all aspects nor delineate the scope of any or all aspects. Its sole purpose is to present some concepts of one or more embodiments in a simplified form as a prelude to the more detailed description that is presented later. For convenience, the term some embodiments may be used herein to refer to a single embodiment or multiple embodiments of the disclosure.

Certain embodiments disclosed herein include a method for identification of a deviation from an expected activities sequence. The method comprises receiving at least one recipe as an input from a user device; generating a sequence of expected signatures respective of the at least one recipe; receiving a sequence of multimedia segments from the user device; generating, by a signature generator system, at least one signature for each multimedia segment of the sequence of multimedia segments; matching each of the at least one signature to at least a portion of the expected sequence of signatures; and providing a notification to the user device upon identification of a deviation from an expected match.

Certain embodiments disclosed herein also include a system for identification of a deviation from an expected activities sequence. The system comprises: a network interface for allowing connectivity to at least one user device; a processing unit; and a memory connected to the processing unit, the memory containing instructions that when executed by the processing unit, configure the system to: receive at least one recipe as an input from the user device; generate a sequence of expected signatures respective of the at least one recipe; receive a sequence of multimedia segments from the user device; generate at least one signature for each multimedia segment of the sequence of multimedia segments; match each of the at least one signature to at least a portion of the expected sequence of signatures; and provide a notification to the user device upon identification of a deviation from an expected match.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosure will be apparent from the following detailed description taken in conjunction with the accompanying drawings.

FIG. 1 is a schematic block diagram of a network system utilized to describe the various embodiments disclosed herein;

FIG. 2 is a block diagram depicting the basic flow of information in the signature generator system according to an embodiment;

FIG. 3 is a diagram showing the flow of patches generation, response vector generation, and signature generation in a large-scale speech-to-text system according to an embodiment; and

FIG. 4 is a flowchart describing the process of identifying deviations from a series of instructions of a recipe respective of multimedia segments received from a user device according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

Certain exemplary embodiments disclosed herein provide a system for tracking user activities through multimedia segments captured by a user device such as, for example a wearable computer device (WCD). The system receives at least one recipe as an input; the recipe includes a list of ingredients and a series of instructions for utilizing the ingredients. The system then generates a multimedia sequence of segments respective of the recipe. A sequence of expected signatures is generated respective of each multimedia segment the multimedia sequence of segments and of the recipe. The system continuously receives multimedia segments from the at least one user device; the multimedia segments comprise a sequence of multimedia segments. Then, the system matches the generated signatures to the signatures generated respective of the recipe. Upon identification of at least one deviation from the recipe, a notification is provided to the user. According to one embodiment, data related to the recipe and the users activities is stored in a data warehouse for further use.

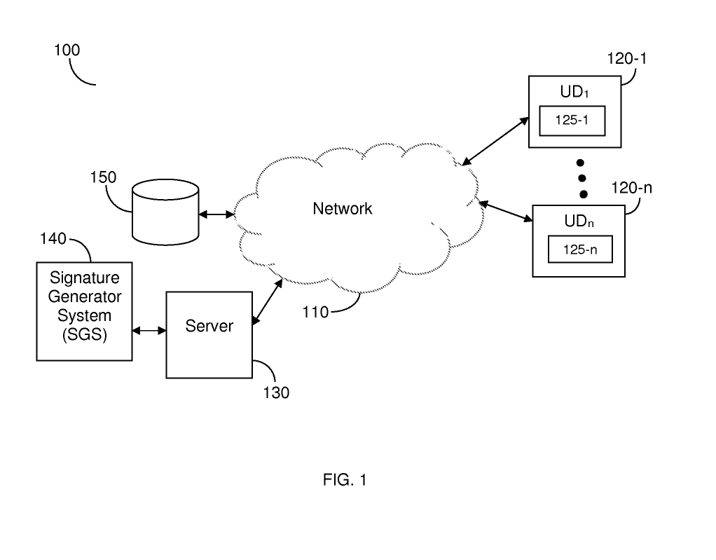

FIG. 1 shows an exemplary and non-limiting schematic diagram of a network system 100 utilized to describe the various embodiments disclosed herein. A network 110 is used to communicate between different parts of the system 100. The network 110 may be the Internet, the world-wide-web (WWW), a local area network (LAN), a wide area network (WAN), a metro area network (MAN), and other networks capable of enabling communication between the elements of the system 100. One of ordinary skill in the art would realize that, while a network system 100 is discussed herein, a stand-alone implementation that does not involve online activities may be implemented according to the principles disclosed herein without deviating from the scope of the disclosure.

Further connected to the network 110 is a plurality of user devices 120-1 through 120-n (collectively referred to hereinafter as user devices 120 or individually as a user device 120). A user device 120 may be, for example, a personal computer (PC), a personal digital assistant (PDA), a mobile phone, a smart phone, a tablet computer, and other kinds of wired and mobile appliances, equipped with capturing, storing, managing capabilities, and the like, that are enabled as further discussed herein below. In a preferred embodiment, a user device 120 is a wearable computing device (WCD). Each of the user devices 120 may further comprise application software (apps) 125-1 through 125-n (collectively referred to hereinafter as apps 125 or individually as an app 125) installed therein. The apps 125 may be downloaded from an application repository such as the AppStore®, Google Play®, and the like.

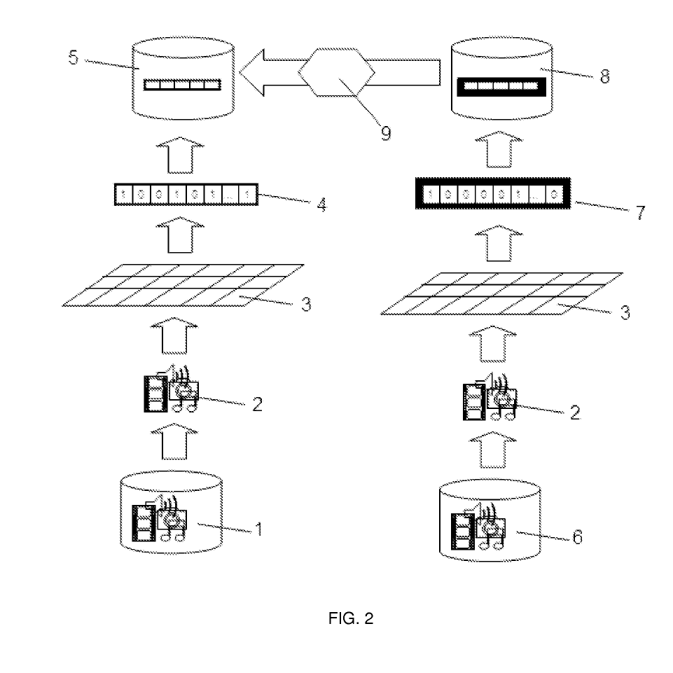

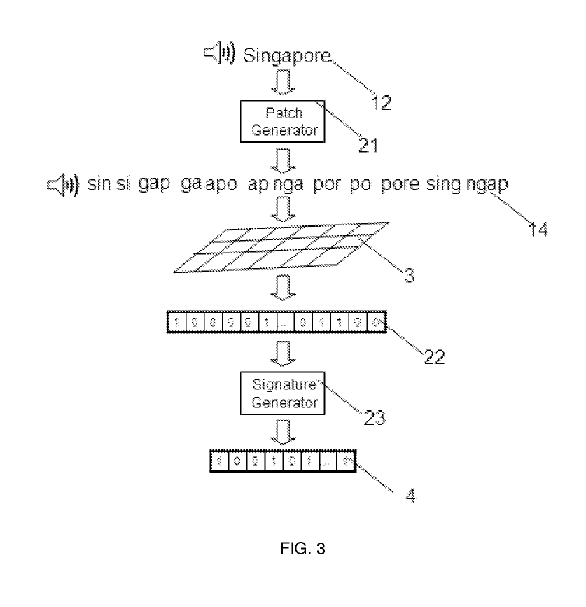

The embodiments discussed herein, not to be viewed as limiting embodiments, may be realized using a server 130 and a signature generator system (SGS) 140. The SGS 140 may be connected to the server 130 directly or through the network 110. The server 130 is enabled to receive and serve multimedia segments that comprise a sequence of multimedia segments and cause the SGS 140 to generate a signature respective of each multimedia segment of the multimedia segments. A multimedia segment may be, for example, an image, a graphic, a video signal, an audio signal, a photograph, and an image of signals (e.g., spectrograms, phasograms, scalograms, and the like), and/or combinations thereof and portions thereof. The process of generating the signatures is explained in more detail herein below with respect to FIGS. 2 and 3.

It should be noted that each of the server 130 and the SGS 140 typically comprises a processing unit, such as a processor (not shown) that is coupled to a memory (not shown). The memory contains instructions that can be executed by the processing unit. The instructions, when executed by the processing unit, cause the processing unit to perform the various functions described herein. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information. The server 130 also includes a network interface (not shown) to the network 110.

The server 130 further communicates with a data warehouse 150 through the network 110. In other non-limiting configurations, the server 130 is directly connected to the data warehouse 150. The data warehouse 150 stores the multimedia segments, recipes received as inputs, and deviation from recipes as determined by the server 130.

According to the disclosed embodiments, the server 130 is configured to receive at least one recipe from the user device 120. A recipe includes a series of instructions and a list of ingredients. For example, a recipe may be instructions to prepare a culinary dish, such as the ingredients and steps necessary to prepare a chocolate chip cupcake. The recipe may be received as a response to a textual query, a selection from one or more queries in a database, or simply as an input from the WCD provided as multimedia segments that are recognized as the recipe. For example, the recipe may be identified through an analysis of multimedia segments captured by the user device 120 and identified by the server 130.

Respective of the recipe, a sequence of multimedia segments is generated by the server 130. Then, a sequence of expected signatures is generated respective of the sequence of multimedia segments. The server 130 is further configured to receive a sequence of multimedia segments from the user device 120. The sequence of multimedia segments is captured by the user device 120 as the user of the user device 120 uses the ingredients in an attempt to follow the recipe. Each multimedia segment received from the user device 120 is analyzed and at least one signature is generated for each multimedia segment by the SGS 140. The signatures generated respective of each of the multimedia segments received from the user device 120 are matched by the server 130 to the expected signatures.

According to another embodiment, an expected concept is generated based on the expected signatures. A concept is a collection of signatures representing elements of the unstructured data and metadata describing the concept. As a non-limiting example, signatures generated for a multimedia segment in which water mixed together with flour represents a concept of preparation of simple dough. A concept is also generated respective of the at least one signature generated for each multimedia segment of the sequence of multimedia segments. Techniques for generating concept structures are also described in U.S. Pat. No. 8,266,185 (hereinafter the “'185 Patent”) to Raichelgauz et al., assigned to common assignee, and is incorporated hereby by reference for all that it contains. The concept generated respective of the multimedia segments received from the user device 120 is matched by the server 130 to the expected concept.

Respective of the match, the server 130 is configured to identify a deviation from the series of instructions and the list of ingredients included in the recipe. Upon identification of a deviation from the series of actions included in the recipe, the server 130 generates a notification. The server 130 may further send the notification to the user device 120 through the network 110. According to one embodiment, the server 130 is further configured to determine the context of the recipe as well as the context of the multimedia segments as further described in the above-referenced co-pending U.S. patent application Ser. No. 13/770,603. Respective thereto, the server 130 is configured to identify a deviation from the recipe based on the context.

As an example, the server 130 is configured to receive a recipe that includes instructions on how to prepare a pancake and the required ingredients. The recipe is received by a wearable user device 120, for example, optical head-mounted display (OHMD) device that includes an interface through which the recipe is received as text or an image of a set of text.

The recipe steps include: combining flour, baking powder, salt, and sugar in a large bowl; making a cavity in the center of a mixture of the ingredients; and adding milk, an egg, and melted butter into the cavity. The head mounted user device 120 monitors the user performing these steps and transmits a sequence of multimedia segments that is received by the server 130. At least one signature is generated respective of each multimedia segment of the sequence of multimedia segments by the SGS 140. Based on the signatures, the actions performed by the user as captured by the head mounted user device 120 are matched to the series of instructions and the list of ingredients included in the recipe. Upon identification of a deviation from the instructions and/or the ingredients, a notification is provided to the user by the head mounted user device 120.

According to this example, if the milk is being poured prior to the sifting of the flour, the baking powder, the salt, and the sugar, a notification of the deviation is generated by the server 130 and displayed over the display of the head mounted user device 120. According to one embodiment, the notification may be constantly displayed until the deviation is eliminated. In another embodiment, the notification may be constantly displayed until the user disables the notification.

FIGS. 2 and 3 illustrate the generation of signatures for the multimedia segments by the SGS 140 according to one embodiment. An exemplary high-level description of the process for large scale matching is depicted in FIG. 2. In this example, the matching is for a video content.

Video content segments 2 from a Master database (DB) 6 and a Target DB 1 are processed in parallel by a large number of independent computational cores 3 that constitute an architecture for generating the signatures (hereinafter the “Architecture”). Further details on the computational cores generation are provided below. The independent cores 3 generate a database of Robust Signatures and Signatures 4 for Target content-segments 5 and a database of Robust Signatures and Signatures 7 for Master content-segments 8. An exemplary and non-limiting process of signature generation for an audio component is shown in detail in FIG. 2. Finally, Target Robust Signatures and/or Signatures are effectively matched, by a matching algorithm 9, to Master Robust Signatures and/or Signatures database to find all matches between the two databases.

To demonstrate an example of the signature generation process, it is assumed, merely for the sake of simplicity and without limitation on the generality of the disclosed embodiments, that the signatures are based on a single frame, leading to certain simplification of the computational cores generation. The matching system is extensible for signatures generation capturing the dynamics in-between the frames.

The signatures' generation process is now described with reference to FIG. 3. The first step in the process of signatures generation from a given speech-segment is to breakdown the speech-segment to K patches 14 of random length P and random position within the speech segment 12. The breakdown is performed by the patch generator component 21. The value of the number of patches K, random length P, and random position parameters is determined based on optimization, considering the tradeoff between accuracy rate and the number of fast matches required in the flow process of the server 130 and SGS 140. Thereafter, all the K patches are injected in parallel into all computational cores 3 to generate K response vectors 22, which are fed into a signature generator system 23 to produce a database of Robust Signatures and Signatures 4.

In order to generate Robust Signatures, i.e., Signatures that are robust to additive noise L (where L is an integer equal to or greater than 1) by the computational cores 3, a frame ‘i’ is injected into all the cores 3. Then, cores 3 generate two binary response vectors: \vec{S} which is a Signature vector, and \vec{RS} which is a Robust Signature vector.

For generation of signatures robust to additive noise, such as White-Gaussian-Noise, scratch, etc., but not robust to distortions, such as crop, shift and rotation, etc., a core Ci={ni} (1≦i≦L) may consist of a single leaky integrate-to-threshold unit (LTU) node or more nodes. The node ni equations are:

$${V}_{i} = {\sum }_{j} {w}_{ij} {k}_{j}$$

$${n}_{i} = \prod ( Vi - {Th}_{x} )$$

where, π is a Heaviside step function; wᵢⱼ is a coupling node unit (CNU) between node i and image component j (for example, grayscale value of a certain pixel j); kj is an image component ‘j’ (for example, grayscale value of a certain pixel j); Thx is a constant Threshold value, where ‘x’ is ‘S’ for Signature and ‘RS’ for Robust Signature; and Vi is a Coupling Node Value.

The Threshold values Thx are set differently for signature generation and for Robust Signature generation. For example, for a certain distribution of Vi values (for the set of nodes), the thresholds for Signature (Th_{S}) and Robust Signature (Th_{RS}) are set apart, after optimization, according to at least one or more of the following criteria:

1: For: Vᵢ>Th_{RS}

1−p(V>Th_{S})−1−(1−ε)^{l}>>1

i.e., given that l nodes (cores) constitute a Robust Signature of a certain image I, the probability that not all of these I nodes will belong to the Signature of same, but noisy image, Ĩ is sufficiently low (according to a system's specified accuracy).

2: p(Vᵢ>Th_{RS})≈l/L

i.e., approximately l out of the total L nodes can be found to generate a Robust Signature according to the above definition.

3: Both Robust Signature and Signature are generated for certain frame i.

It should be understood that the generation of a signature is unidirectional, and typically yields lossless compression, where the characteristics of the compressed data are maintained but the uncompressed data cannot be reconstructed. Therefore, a signature can be used for the purpose of comparison to another signature without the need of comparison to the original data. The detailed description of the signature generation can be found in U.S. Pat. Nos. 8,326,775 and 8,312,031, assigned to common assignee, which are hereby incorporated by reference for all the useful information they contain.

A computational core generation is a process of definition, selection, and tuning of the parameters of the cores for a certain realization in a specific system and application. The process is based on several design considerations, such as:

(a) The cores should be designed so as to obtain maximal independence, i.e., the projection from a signal space should generate a maximal pair-wise distance between any two cores' projections into a high-dimensional space.

(b) The cores should be optimally designed for the type of signals, i.e., the cores should be maximally sensitive to the spatio-temporal structure of the injected signal, for example, and in particular, sensitive to local correlations in time and space. Thus, in some cases a core represents a dynamic system, such as in state space, phase space, edge of chaos, etc., which is uniquely used herein to exploit their maximal computational power.

(c) The cores should be optimally designed with regard to invariance to a set of signal distortions, of interest in relevant applications.

A detailed description of the computational core generation and the process for configuring such cores is discussed in more detail in the above-referenced U.S. Pat. No. 8,655,801.

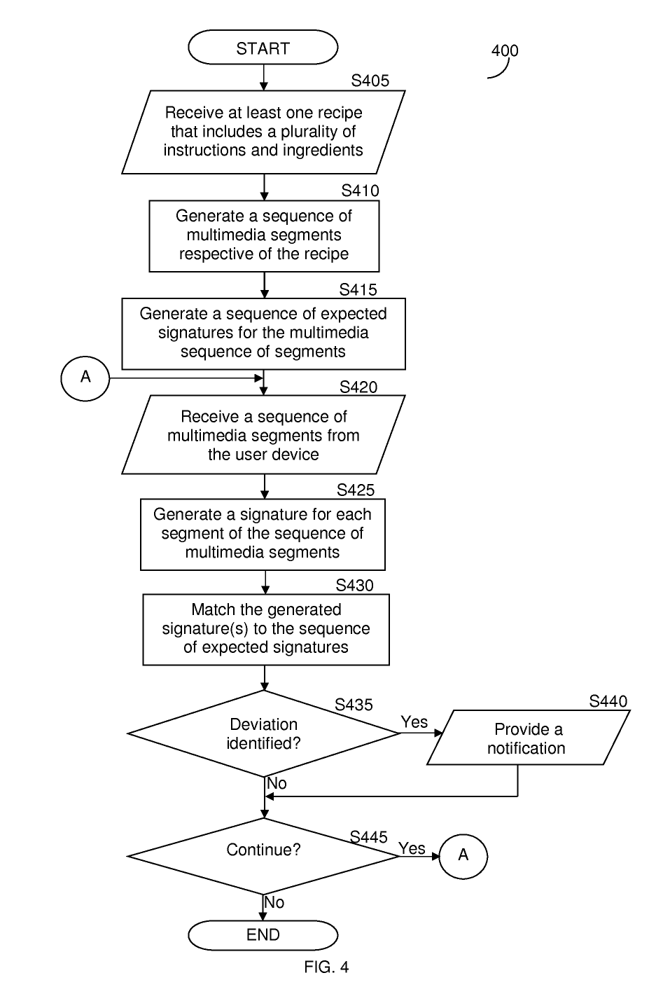

FIG. 4 depicts an exemplary and non-limiting flowchart 400 describing the process of identifying deviations from a series of instructions in multimedia segments according to an embodiment. In S405, at least one recipe that includes a series of instructions and ingredients is received from a user device 120, for example, the user device 120-1.

In S410, a sequence of multimedia segments is generated respective of the recipe. In an embodiment, the sequence of multimedia segments generated respective of the recipe is generated by a server, such as the server 130. In S415, a sequence of expected signatures is generated respective of the sequence of multimedia segments. According to another embodiment, the sequence of generated signatures is generated respective of the recipe. The signatures are generated by a SGS 140 as described below with respect to FIGS. 2 and 3.

In S420, a sequence of multimedia segments is received from a user device (e.g., the user device 120). In this embodiment, the sequence of multimedia segments depicts a user attempting to follow a recipe at various stages in the instructions. In S425, at least one signature is generated for each multimedia segment. In S430, the signatures generated respective of the multimedia segments are matched to at least a portion of the sequence of expected signatures.

In S435, it is checked whether at least one deviation from the at least one recipe is identified and, if so, execution continues with S440; otherwise, execution continues with S445. In an embodiment, a deviation may be identified when, e.g., the signatures generated respective of the multimedia segments demonstrates matching with the sequence of expected signatures below a predefined threshold. In S440, a notification respective of the deviation is provided to the user device. In S445, it is checked whether to continue with the operation and if so, execution continues with S410; otherwise, execution terminates.

For example, a recipe for cooking spaghetti is received from a pair of smart glasses worn by a user. In this example, the recipe includes placing water in a pot, boiling the water, adding salt, adding pasta, and stirring. A sequence of multimedia segments is generated respective of the recipe for cooking spaghetti. The segments may be images of an example user cooking spaghetti. A sequence of expected signatures is generated respective of the existing sequence of multimedia segments. The user begins to follow the recipe, forgets to boil water, and a sequence of multimedia segments depicting the user attempting to cook the spaghetti is received from the smart glasses. At least one signature is generated for each received multimedia segment. The generated signatures are compared to the expected signatures. It is determined that the user deviated from the recipe by failing to boil the water. After the comparison, a notification is displayed to the user by the smart glasses indicating that the user forgot to boil water.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiments and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for identification of a deviation from an expected activities sequence, comprising:
receiving at least one recipe as an input from a user device;
generating a sequence of expected signatures respective of the at least one recipe;
receiving a sequence of multimedia segments from the user device;
generating at least one signature for each multimedia segment of the sequence of multimedia segments;
matching each of the at least one signature to at least a portion of the expected sequence of signatures; and
providing a notification to the user device upon identification of a deviation from an expected match.

2. The method of claim 1, wherein the recipe comprises:
a plurality of ingredients; and
a plurality of instructions for utilizing the plurality of ingredients.

3. The method of claim 1, further comprising:
generating an expected sequence of multimedia segments respective of the recipe; and
generating a sequence of expected signatures respective of the generated expected sequence of multimedia segments.

4. The method of claim 1, further comprising:
generating at least one concept respective of the at least one signature generated for each multimedia segment of the sequence of multimedia segments;
generating at least one expected concept respective of the expected signatures;
matching the at least one generated concept to the at least one expected concept; and
providing a notification to the user device upon identification of a deviation from an expected concept match.

5. The method of claim 1, wherein the multimedia segment is any one of: an image, a graphic, a video signal, an audio signal, a photograph, an image of signals, a combination thereof, and a portion thereof.

6. The method of claim 1, further comprising:
storing data related to the recipe and to the sequence of multimedia segments from the user device in a data warehouse.

7. The method of claim 1, wherein the user device is at least a wearable computing device.

8. The method of claim 1, further comprising:
determining the context of the at least one recipe;
determining the context of the sequence of multimedia segments;
matching the context of the at least one recipe with the context of the sequence of multimedia segments; and
providing a notification to the user device upon identification of a deviation from an expected context match.

9. A non-transitory computer readable medium having stored thereon instructions for causing one or more processing units to execute the method according to claim 1.

10. A system for identification of a deviation from an expected activities sequence, comprising:
a network interface for allowing connectivity to at least one user device;
a processing unit; and
a memory connected to the processing unit, the memory containing instructions that when executed by the processing unit, configure the system to:
receive at least one recipe as an input from the user device;
generate a sequence of expected signatures respective of the at least one recipe;
receive a sequence of multimedia segments from the user device;
generate at least one signature for each multimedia segment of the sequence of multimedia segments;
match each of the at least one signature to at least a portion of the expected sequence of signatures; and
provide a notification to the user device upon identification of a deviation from an expected match.

11. The system of claim 10, wherein the recipe comprises:
a plurality of ingredients; and
a plurality of instructions for utilizing the plurality of ingredients.

12. The system of claim 10, wherein the system is further configured to:
generate an expected multimedia sequence of segments respective of the recipe; and
generate a sequence of expected signatures respective of the generated expected multimedia sequence of segments.

13. The system of claim 10, wherein the system is further configured to:
generate at least one concept respective of the at least one signature generated for each multimedia segment of the sequence of multimedia segments;
generate at least one expected concept respective of the expected signatures;
match the at least one concept to the at least one expected concept; and
provide a notification to the user device upon identification of a deviation from an expected concept match.

14. The system of claim 10, wherein the multimedia segment is any one of: an image, a graphic, a video signal, an audio signal, a photograph, an image of signals, a combination thereof, and a portion thereof.

15. The system of claim 10, wherein the system is further configured to:
store data related to the recipe and to the sequence of multimedia segments from the user device in a data warehouse.

16. The system of claim 10, wherein the user device is at least a wearable computing device, a smart phone, and a tablet computer.

17. The system of claim 10, wherein the system is further configured to:
determining the context of the at least one recipe;
determining the context of the sequence of multimedia segments;
matching the context of the at least one recipe with the context of the sequence of multimedia segments; and
providing a notification to the user device upon identification of a deviation from an expected context match.
